(19) United States
(12) Patent Application Publication
(10) Pub. No.: US 2006/0137835 A1
(43) Pub. Date: Jun. 29, 2006

(54) Reinforced sectional door panels

(75) Inventors: Willis J. Mullet, Gulf Breeze, FL (US); Thomas B. Bennett III, Wooster, OH (US); Albert W. Mitchell, Cantonment, FL (US); James A. Mast, Millersburg, OH (US); Allen C. McDowell, Blue Springs, MS (US)

Correspondence Address: Phillip L. Kenner;RENNER, KENNER, GREIVE, BOBAK, TAYLOR & WEBER, Fourth Floor, First National Tower, Akron, OH, 44308-1456, US

(73) Assignee: WAYNE-DALTON CORP.

(21) Appl. No.: 11/020,487

(22) Filed: Dec. 23, 2004

(51) Int. Cl. E06B 3/12

(52) U.S. Cl. 160/236

(57) ABSTRACT

A sectional doorpanel (P, P′; P″) having a facer (50; 94; 114), a backer (52; 96; 116), a core (54; 98; 117) interposed between the facer and the backer, the backer including at least one protruding element (60A, 60B) extending outwardly therefrom and longitudinally thereof, and a reinforcing member (66, 76) positioned longitudinally along the protruding element and a reinforcing strip (90; 112, 113) positioned adjacent one of an upper edge (112) and a lower edge (113) of the panels and extending longitudinally thereof.

### TECHNICAL FIELD

The present invention relates generally to movable barriers such as sectional doors commonly used to selectively open and close openings in residential and commercial buildings. More particularly, the present invention relates to reinforced sectional doors that are configured to withstand substantially greater wind-loading conditions than conventional doors. More specifically, the present invention relates to a panel reinforcement system employing stiffening elements that may be incorporated in or added to the panels of sectional doors during manufacturing to enhance resistance to wind-load forces.

### BACKGROUND ART

Due to relatively high incidence of severe weather in hurricane zones where high wind conditions have caused a considerable amount of damage to residential and commercial buildings, there recently has been a greater awareness that sectional doors, if strengthened, could prevent damage to the structures. This can have the effect of greater safety for occupants of the structure in terms of reduced likelihood of injury to occupants, as well as providing an avenue for escape from the structure if necessary. Further, high winds of at least short duration occur in nearly all geographic areas.

Initially, efforts to strengthen sectional doors resulted in proposals for increasing the material thickness and yield strength of door panels. However, uniformly increasing the material thickness or cross-sectional thickness of the door panels does not correspondingly provide proportionately additional resistance to wind-load forces. Rather, the increased weight of door panels with increased uniform material thicknesses may adversely affect many other components of sectional doors. For example, as the weight of the door panels increases, operators and counterbalance systems must be configured to accommodate the additional weight. Moreover, the track system and fastening requirements for the track system must be reinforced to accommodate the additional weight. Such modifications add additional expense to sectional doors without appreciably increasing resistance to wind-load forces. Therefore, because the additional weight provided by uniformly increasing the material thickness of the door panels adversely affects the overall cost of sectional doors without providing appreciable additional resistance to wind-load forces, efforts to strengthen sectional doors have focused on other solutions.

For example, other efforts to strengthen sectional doors resulted in the addition of protruding elements such as beams and channels to the inner facers of the door panels and the use of wind-load kits. The protruding elements extend inwardly from the door panels at various intervals, and can be integrally formed with the inner facers of the door panels. For example, when the door panels are formed by laminated outer facers and inner facers sandwiching a substrate, the protruding elements can be formed from bends in the inner facers or backers ultimately filled with the substrate. The protruding elements serve to resist bending moments generated by wind-load forces without adding significant extra weight to the door panels. However, inward extension of the protruding elements, and, hence, the amount of resistance to bending moments provided by the protruding elements, is limited due to possible interference created thereby during the movement of the door panels. That is, because protruding elements increase the dimensional profiles of the door panels, their tolerable inward extension is limited due to the danger presented to bystanders or objects in a building during the movement of the door panels.

Wind-load kits generally consist of reinforcing members, such as channels, struts and/or beams fastened to inner facers of the door panels during, or in some instances, after installation. The reinforcing members provided as part of wind-load kits also serve to resist bending moments generated by wind-load forces, but normally add appreciable extra weight to the door panels. Further, wind-load kits are oftentimes difficult to install, and, for areas outside of hurricane zones, their material cost and the additional cost of installation may not be justified. For example, to provide enough resistance to bending moments generated by wind-load forces, many smaller reinforcing members may be utilized. Moreover, use of such reinforcing members in wind-load kits normally requires use of mechanical fasteners which increase the weight of the door panels, and makes such reinforcing members time-consuming to install. Consequently, use of add-on reinforcing members to the inner facers not only increases the cost of their installation, but also increases the weight of the door panels, which, as discussed above, adversely affects the overall cost of sectional doors.

Still other efforts to strengthen sectional doors resulted in the door panels including hollow extruded plastic rail members and interconnecting stile members that are adapted to receive internal tubular or channel shaped metal reinforcing members to minimize the deflection of a resultant door section under loading conditions. The door sections also are adapted to receive externally fitted struts at a longitudinal side edge of a panel connected to an internal reinforcing member disposed in a rail member without forcible connection to the rail to allow for differential thermal expansion between the rail member and the reinforcing members.

Consequently, there is a need for a panel reinforcement system which can be incorporated into door panels without significant additional expense, without adding substantial additional weight, and without imparting disadvantageous features.

### DISCLOSURE OF THE INVENTION

Therefore, an object of the present invention is to provide a panel reinforcement system which can be permanently incorporated into the panels of sectional doors during construction to strengthen the sectional doors against wind-load forces. Another object of the invention is to provide a panel reinforcement system which can resist bending moments generated by the wind-load forces. A further object of the invention is to provide a reinforcement system for a panel for a door, wherein approximately 70% of the weight of the reinforcing elements is oriented substantially parallel to the wind force direction, i.e., perpendicular to the plane of the door in the closed vertical position. Another object of the invention is to provide a panel configuration wherein the panel backers distribute wind forces impinging upon the reinforcing members.

A further object of the present invention is to provide a panel reinforcement system which can be cost-effectively incorporated into door panels without adding significant additional expense to the door panels. Another further object of the present invention is to provide a panel reinforcement system which provides an acceptable strength to weight ratio allowing for use on relatively light door panels without having to significantly reconfigure operators, counterbalance systems, track systems, and fastening requirements for the track systems to accommodate any additional weight. Another object of the invention is to provide panel reinforcement members which do not require fasteners, straps or brackets to be maintained in position.

Another object of the present invention is to provide reinforcing members for panels that do not protrude into a building further than the backer normally provided for the door panels.

In general, the present invention contemplates a sectional door panel having a facer, a backer, a core interposed between the facer and the backer, the backer including at least one protruding element extending outwardly therefrom and longitudinally thereof, a reinforcing member positioned longitudinally along the protruding element and a reinforcing strip positioned adjacent one of an upper edge and a lower edge of the panels and extending longitudinally thereof.

### BRIEF DESCRIPTION OF THE DRAWINGS

FIG. 1 is an interior perspective view of a sectional door employing one embodiment of the panel reinforcement system according to the concepts of the present invention;

FIG. 2 is a cross-sectional view of an upper intermediate panel and a lower intermediate panel taken substantially along line 2-2 of FIG. 1 showing a panel reinforcement system employing reinforcing elements positioned interiorly of the panels;

FIG. 3 is an enlarged fragmentary view of a portion of FIG. 2 showing a reinforcing element positioned interiorly of the lower intermediate panel;

FIG. 3A is an enlarged fragmentary view similar to FIG. 3 of a portion of the lower intermediate panel showing another embodiment of a reinforcing element.

FIG. 3B is an enlarged fragmentary view similar to FIG. 3 of a portion of the lower intermediate panel showing yet another embodiment of a reinforcing element.

FIG. 3C is an enlarged fragmentary view similar to FIG. 3 of a portion of the lower intermediate panel showing still another embodiment of a reinforcing element.

FIG. 3D is an enlarged fragmentary view similar to FIG. 3 of a portion of the lower intermediate panel showing yet still another embodiment of a reinforcing element.

FIG. 3E is an enlarged fragmentary view similar to FIG. 3 of a portion of the lower intermediate panel showing yet still another embodiment of a reinforcing element.

FIG. 4 is a cross-sectional view of the upper intermediate panel and the lower intermediate panel of the door of FIG. 1 showing an alternate panel reinforcement system employing reinforcing elements positioned exteriorly of the panel;

FIG. 5 is an enlarged fragmentary view of a portion of FIG. 4 showing a reinforcing element positioned exteriorly of the lower intermediate panel;

FIG. 6 is a cross-sectional view of the upper intermediate panel and the lower intermediate panel of an alternate panel configuration showing a panel reinforcement system employing reinforcing elements positioned on the interior of the panels;

FIG. 7 is an enlarged fragmentary view of a portion of FIG. 6;

FIG. 8 is a cross-sectional view of the upper intermediate panel and the lower intermediate panel showing a panel reinforcement system employing reinforcing elements formed integrally with a skin of the panel and positioned on the interior of the panels; and

FIG. 9 is an enlarged fragmentary view of a portion of FIG. 8.

### BEST MODE FOR CARRYING OUT THE INVENTION

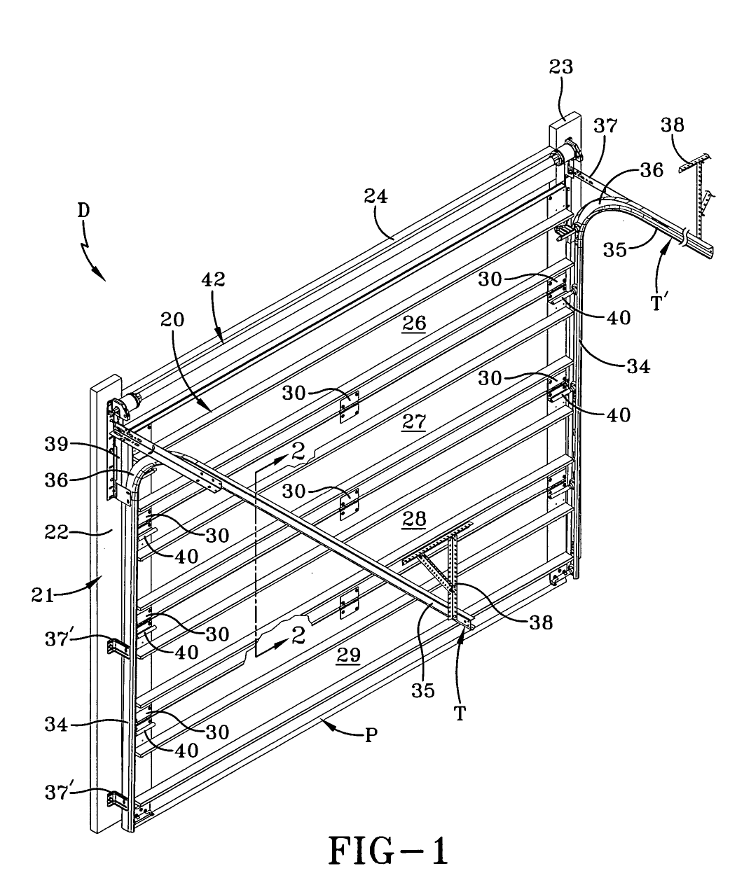

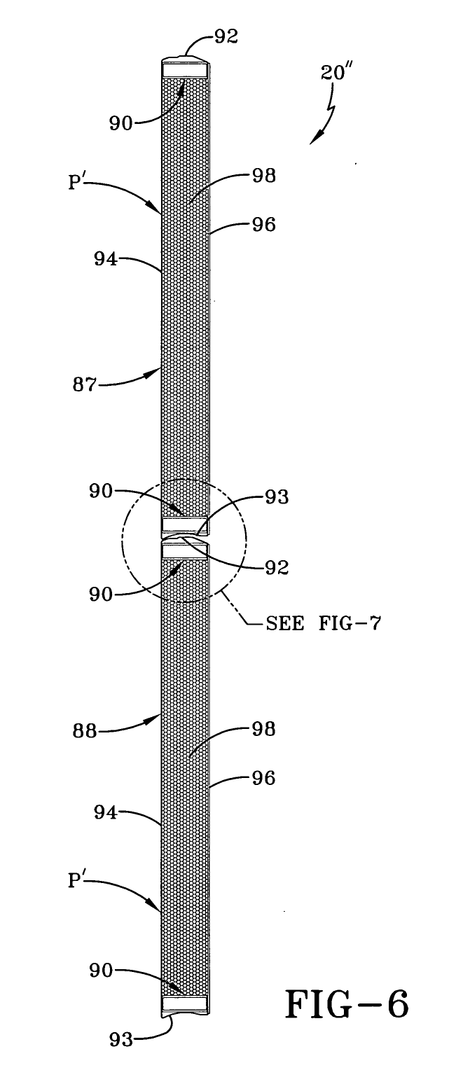

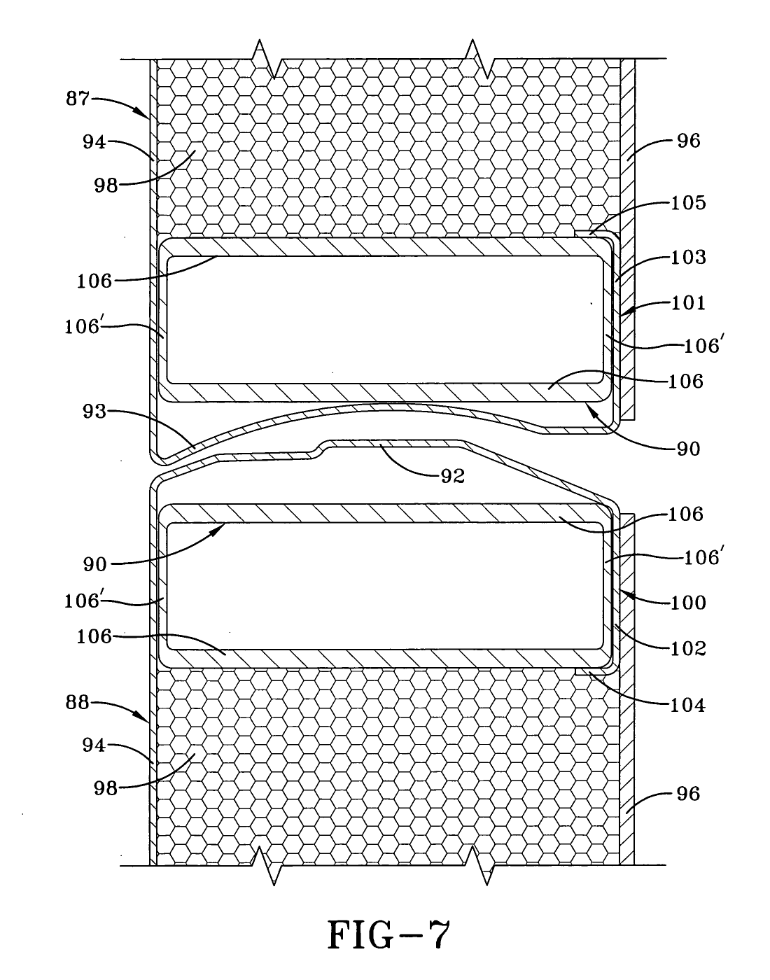

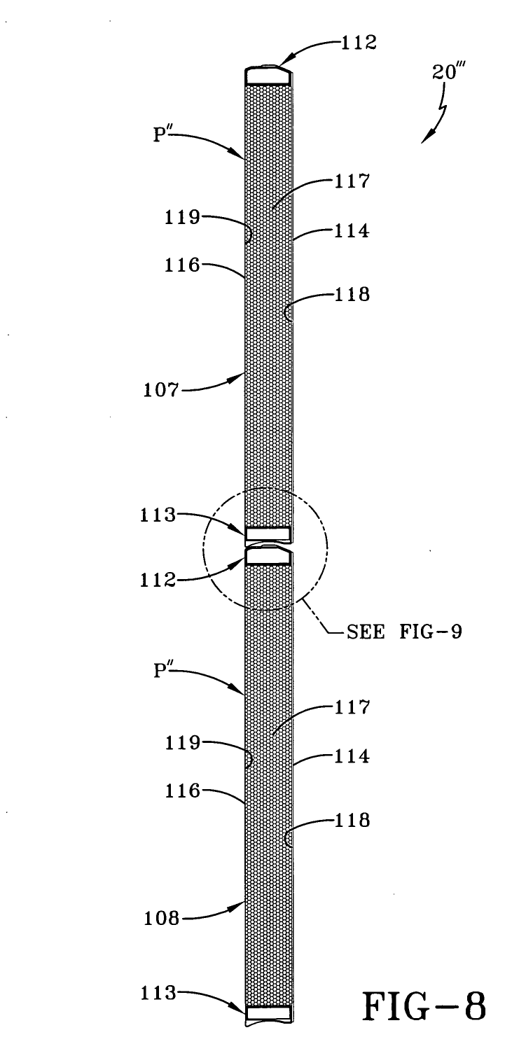

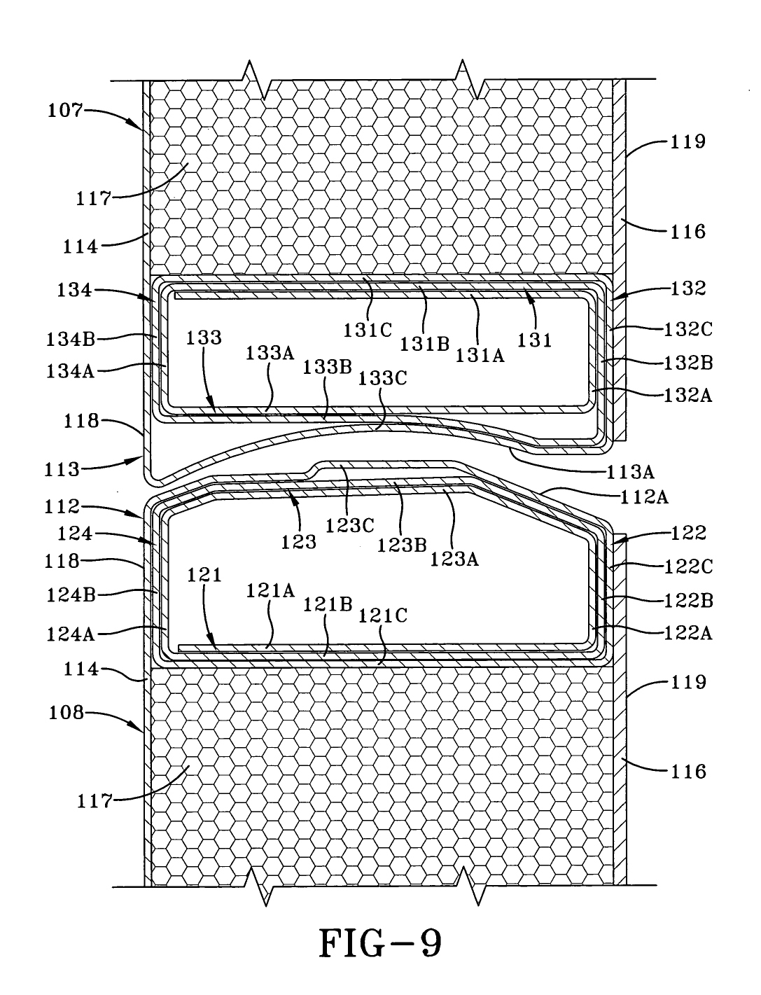

The panel reinforcement system according to the concepts of the present invention is generally indicated by the numeral 20 in FIG. 1 of the drawings. Three groups of panels P, P′, and P″ are used to illustrate the various features of the panel reinforcement system 20. Although only the panels P are depicted in FIG. 1, each group of panels P, P′, and P″ can be used in forming a sectional door D. Each group of panels P, P′, P″ ideally includes at least an upper panel, an upper intermediate panel, a lower intermediate panel, and a lower panel. As such, although only the upper intermediate panels and lower intermediate panels are depicted in association with panels P′ in FIGS. 6 and 7 and with panels P″ in FIGS. 8 and 9, the sectional doors D formed thereby also ideally include upper panels and lower panels, as shown in conjunction with panels P in FIGS. 1-5. However, as those skilled in the art will appreciate, the groups of panels P, P′, and P″ includes as many panels as are required for a particular opening height.

An exemplary sectional door D employing the panel reinforcement system 20 is commonly used in residential and commercial buildings, and is positioned for opening and closing movements relative to an opening defined by a frame 21. The frame 21 includes a pair of spaced jambs 22 and 23 joined adjacent their vertical upper extremities by a header 24. The frame 21 delineates a generally inverted U-shape around the opening. As those skilled in the art will appreciate, the frame 21 is normally constructed of lumber for purposes for reinforcement and to facilitate the attachment of elements supporting the sectional door D.

As depicted in FIG. 1, the sectional door D is formed using the panels P. As shown, the panels P include an upper panel 26, an upper intermediate panel 27, a lower intermediate panel 28, and a lowerpanel 29. Just as adjacent panels P′ and adjacent panels P″ would be, adjacent panels P are hingedly interconnected with one another to permit the opening and closing of the sectional door D. That is, along their panel to panel interfaces, adjacent panels P are interconnected by hinge mechanisms 30 which allow for articulation of the panels P when moving between the opened and closed positions.

The panels P are moveably interrelated with the opening defined by the frame 21 using a track system including tracks T positioned on one side of the opening and tracks T′ positioned on the other side of the opening. The tracks T and T′ each include vertical track sections 34, horizontal track sections 35, and transitional track sections 36 joining vertical track sections 34 and horizontal track sections 35.

The tracks T, T′ are supported relative to the frame 21 by horizontal angles 37, struts 38, and flag angles 39. The flag angles 39 are attached to the jambs 22 and 23 to support the vertical track sections 34. The struts 38 hang down from the overhead (not shown) to support the horizontal track sections 35. The horizontal angles 37 are attached to the flag angles 39 to support the transitional track sections 36 and horizontal track sections 35. Standoffs 37′ space the vertical track sections 34 from the jambs 22, 23. The tracks T and T′ are adapted to receive rollers 40 attached to the panels P. The rollers 40 in cooperation with the hinged interconnections of adjacent panels P afforded by the hinge mechanisms 30 allow for articulated movement of the panels P along the tracks T and T′.

The flag angles 39 can be used to mount a counterbalance system generally indicated by the numeral 42 in FIG. 1. The counterbalance system 42 interacts with the sectional door D to facilitate opening and closing thereof in a manner well known to persons skilled in the art. While a counterbalance system according to Applicant's U.S. Pat. No. 5,419,010 is shown for exemplary purposes in FIG. 1, it will be appreciated by those skilled in the art that any of a variety of different types of counterbalancing systems may be employed.

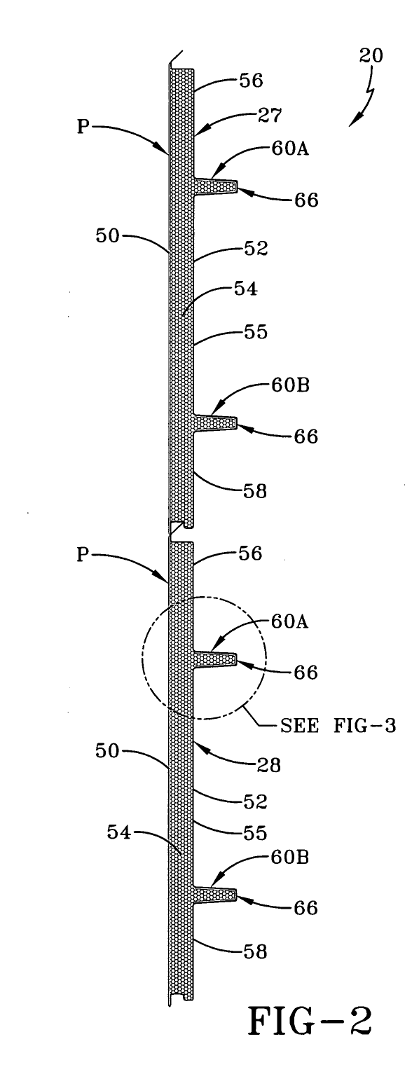

As seen in FIGS. 2-5, the upper intermediate panels 27 and lower intermediate panels 28 (which are exemplary of adjacent panels P) include outer skins or facers 50, inner skins or backers 52, and an insulating foam core 54 interposed between the facers 50 and backers 52. The facers 50 and backers 52 can be laminated to one another using the foam core 54. The foam core 54 is ideally an insulating material, and can be poured and formed in situ to bond the first facers 50 and second facers 52 together. Alternatively, the core 54 can be preformed and bonded to facers 50 and backers 52 by an adhesive in a sandwiching process. Exemplary materials employed to form the foam core 54 include polymeric materials such as polyurethane and polystyrene. The facers 50 and backers 52 can be formed from metallic materials or polymeric materials such as polyurethane or polystyrene.

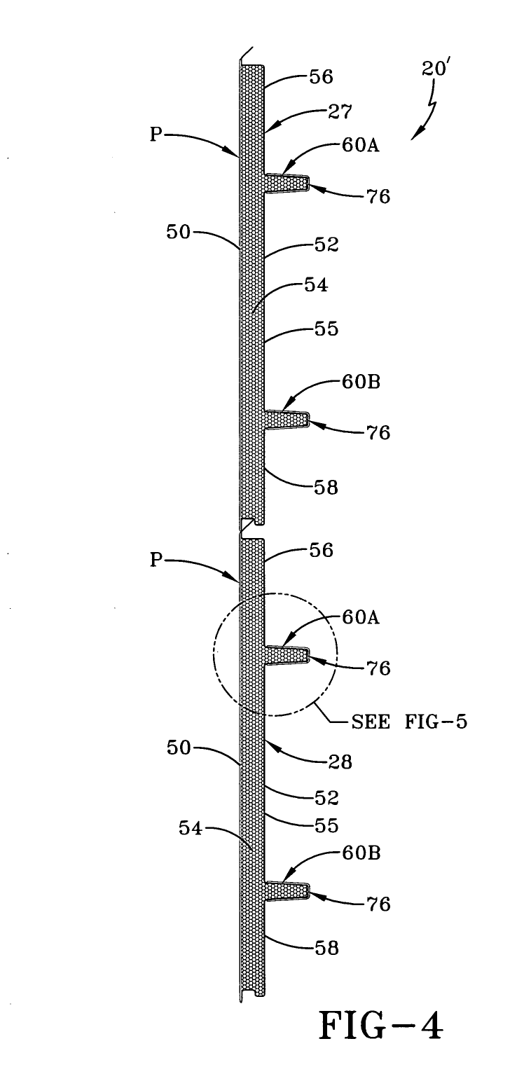

To increase the structural strength thereof, the backers 52 include at least one protruding element extending outwardly therefrom. For example, as seen in FIGS. 2 and 4, the backers 52 include center segments 55, and upper segments 56 and lower segments 58 positioned relative to the center segments 55, all of which may be substantially parallel to facers 50. Interposed between the center segments 55 and upper segments 56 and between the center segments 55 and lower segments 58 are protruding elements such as upper struts 60A and lower struts 60B, respectively. The struts 60A and 60B each include first segments 61 and second segments 62 joined by a interconnecting segment 64. The first segments 61 and second segments 62 may be oppositely slightly inclined with respect to a line perpendicular to the remainder segments 55, 56 and 58 The area defined by struts 60A and 60B may be filled with the foam core 54.

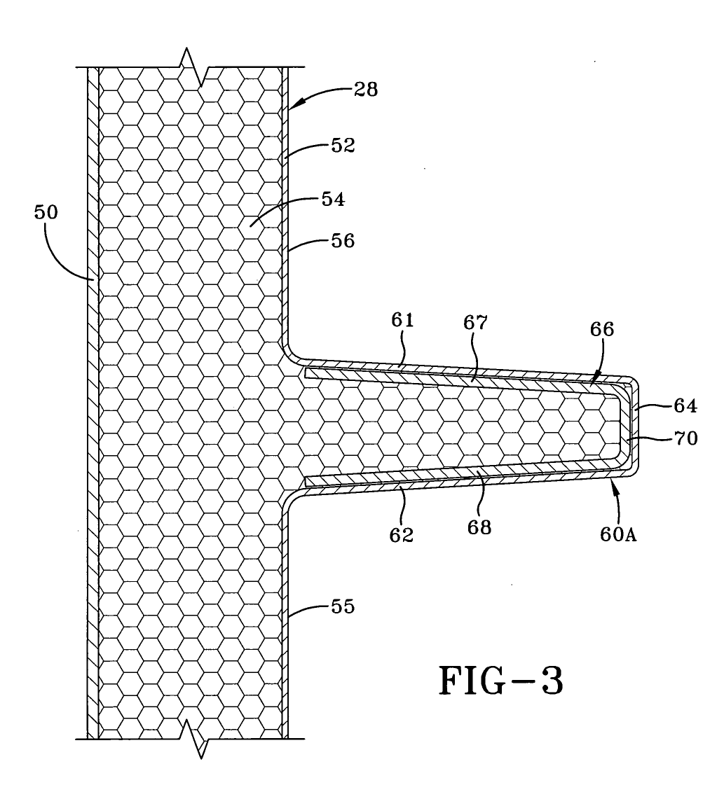

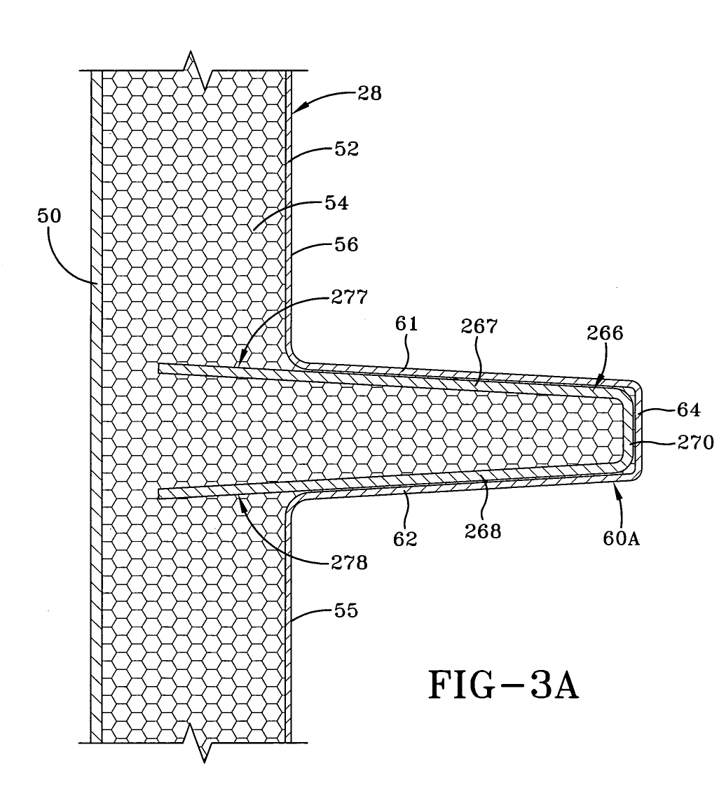

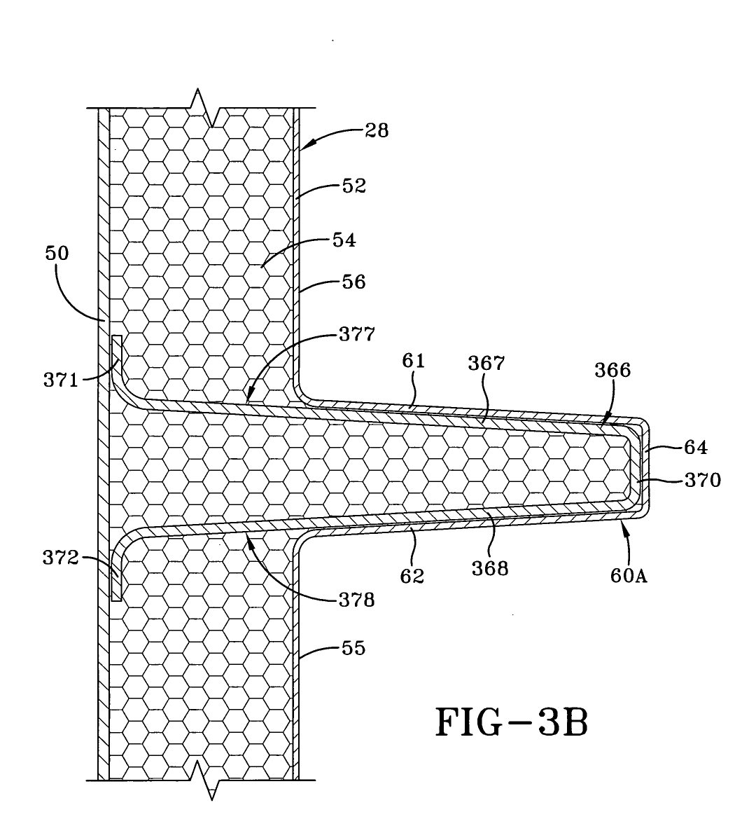

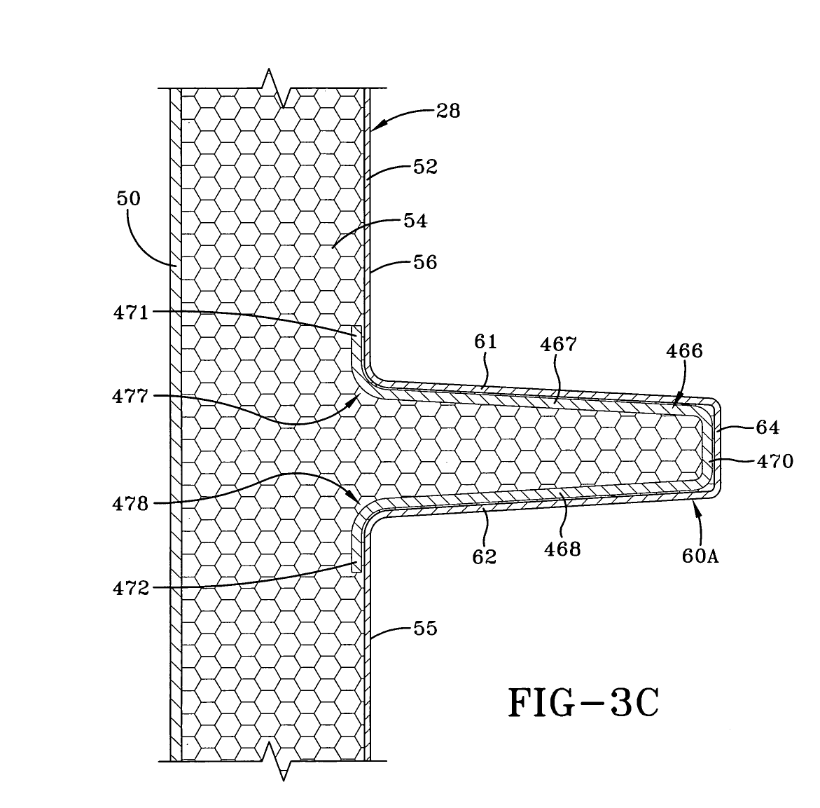

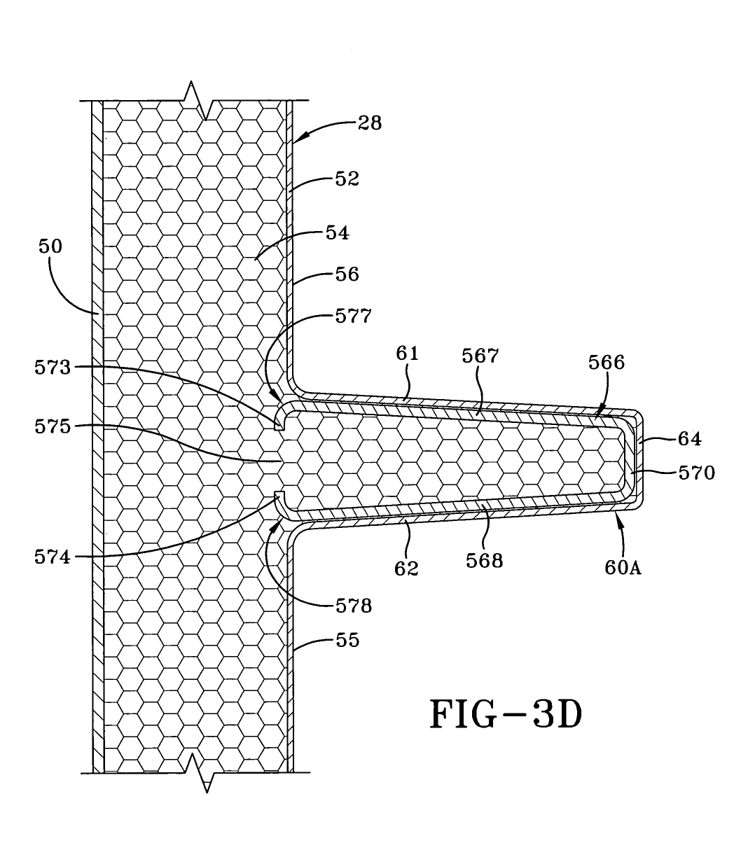

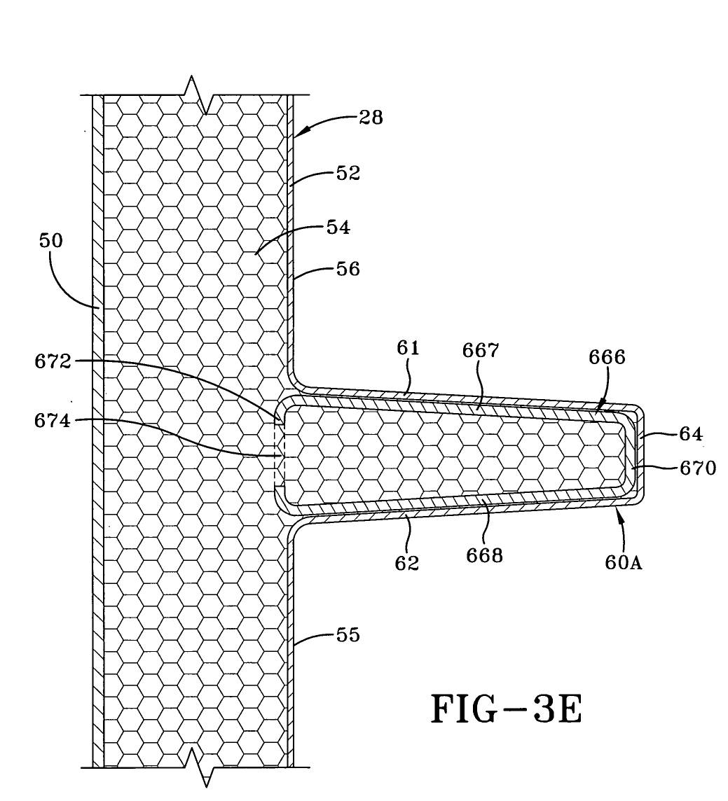

As seen in FIGS. 2 and 3, the panel reinforcement system 20 includes reinforcing cross-members, generally indicated by the numeral 66, that are provided on the interior of and positioned longitudinally along the panels P. The reinforcing cross-members 66 include first portions 67, second portions 68, and interconnecting portions 70 joining first portions 67 and second portions 68. The reinforcing cross-members 66 may conform to the interior dimensions of the struts 60A and 60B. That is, the first portions 67 abut the inner surfaces of the first segments 61, the second portions 68 abut the inner surfaces of the second segments 62, and the interconnecting portions 70 abut the inner surfaces of the interconnecting segments 64.

The reinforcing cross-members 66 are ultimately positioned within and along the interior of the struts 60A and 60B, and are integrally, mechanically, and/or adhesively fastened thereto. As an alternative to mechanical or adhesive fastening, the reinforcing cross-members 66 can be held in place by the foam core 54. As such, during the formation of the foam core 54, the reinforcing cross-members 66 are pressed against the interior of the struts 60A and 60B by the foam core 54 as it is foaming and adhering to the facers 50, backers 52 and cross-members 66. Ultimately, the reinforcing cross-members 66 add strength to the panels P primarily in a direction perpendicular to the plane of facers 50 to resist wind-load forces thereon.

The reinforcing cross-members utilized in the panel reinforcement system 20 can also have the configurations depicted in FIGS. 3A, 3B, 3C, and 3D. Like the reinforcing cross-members 66, the reinforcing cross-members depicted in FIGS. 3A, 3B, 3C, and 3D are provided on the interior of and positioned longitudinally along the panels P to add strength in a direction perpendicular to the plane of the facers 50. These reinforcing cross-members are not only attached within the struts 60A and 60B, but also include portions extending into a portion of the foam core 54 disposed between the facer 50 and backer 52. By extending into the foam core 54, the reinforcing cross-members depicted in FIGS. 3A, 3B, 3C and 3D add further reinforcement to the panels P to resist wind-load forces. For example, the wind-load forces are transferred through these reinforcing cross-members, and, due to the contact between the reinforcing cross-members and foam core 54, are distributed into a portion of the foam core 54. Furthermore, even though the reinforcing cross-members depicted in FIGS. 3A, 3B, 3C, and 3D are shown in association with the strut 60A of lower intermediate panel 28, the reinforcing cross-members be used with both the struts 60A and 60B in any of the panels P.

In the embodiment of FIG. 3A, a reinforcing cross-member, generally indicated by the numeral 266, is provided on the interior of and positioned longitudinally along the lower intermediate panel 28. The reinforcing cross-member 266 includes a first portion 267, a second portion 268, and an interconnecting portion 270 joining the first portion 267 and second portion 268. The reinforcing cross-members 266 (like the reinforcing cross-members 66) can be integrally, mechanically, and/or adhesively fastened within the struts 60A and 60B, or can be held in place inside the struts 60A and 60B by the foam core 54.

As seen in FIG. 3A, the reinforcing cross-members 266 may partially conform to the interior dimensions of the strut 60A to ultimately allow the first portion 267 to abut the inner surface of the first segment 61, the second portion 268 to abut the inner surface of the second segment 62, and the interconnecting portion 270 to abut the inner surface of the interconnecting segments 64. Furthermore, the first portion 267 and second portion 268 can be configured to extend a distance from the interior of the strut 60A and 60B into the foam core 54. As such, the end portions of the first portion 267 and second portion 268, generally indicated by the numerals 277 and 278, respectively, in FIG. 3A are positioned within the foam core 54 disposed between the facer 50 and backer 52. That is, the end portions 277 and 278 extend into and are enveloped by the foam core 54.

The envelopment of the end portions 277 and 278 by the foam core 54 provides for further reinforcement of the panels P. For example, not only are the wind-load forces acting on the reinforcing cross-member 266 transferred to the foam core 54 due to the friction generated because the foam core 54 and end portions 277 and 278 interface, but the wind-load forces are also transferred to the foam core 54 because of the adhesion of the foam core 54 to the end portions 277 and 278. As such, the resistance to shearing action (of the reinforcing cross-member 266 relative to the foam core 54) provided both by the friction between the foam core 54 and end portions 277 and 278, and by adhesion between the foam core 54 and end portions 277 and 278 allows wind-load forces acting on the panels P to be distributed into a portion of the foam core 54.

In the embodiment of FIG. 3B, a reinforcing cross-member, generally indicated by the numeral 366, is provided on the interior of and positioned longitudinally along the lower intermediate panel 28. The reinforcing cross-member 366 includes a first portion 367, a second portion 368, an interconnecting portion 370 joining the first portion 367 and second portion 368, a first out-turned flange 371 depending from the first portion 367 and a second out-turned flange 372 depending from the second portion 368. The reinforcing cross-members 366 (like the reinforcing cross-members 66 and 266) can be integrally, mechanically, and/or adhesively fastened within the struts 60A and 60B, or can be held in place inside the struts 60A and 60B by the foam core 54.

The reinforcing cross-members 366 may partially conform to the interior dimensions of the struts 60A and 60B to ultimately allow the first portion 367 to abut the inner surface of the first segment 61, the second portion 368 to abut the inner surface of the second segment 62, and the interconnecting portion 370 to abut the inner surface of the interconnecting segments 64. Furthermore, the first portion 367 and second portion 368 can be configured to extend from the interior of the struts 60A and 60B through the foam core 54 so that the first out-turned flange 371 and second out-turned flange 372 contact the interior surface of the facer 50. That is, the first portion 367 and second portion 368 have lengths allowing first out-turned flange 371 and second out-turned flange 372 to interface with the interior surface of the facer 50. As such, the first out-turned flange 371 and second out-turned flange 372 can be adhesively and/or mechanically secured to the interior of the facer 50, and the ends of the first portion 367 and second portion 368 generally indicated by the numerals 377 and 378, respectively, in FIG. 3B are positioned within and enveloped by the foam core 54 disposed between the facer 50 and backer 55.

As seen in FIG. 3B, the first out-turned flange 371, second out-turned flange 372, and remainder of the reinforcing cross-member 366 interconnect the backer 52 with the facer 50, and the end portions 377 and 378 are effectively enveloped by the foam core 54. The interconnection of the facer 50 and backer 52 by cross-members 366 stabilizes the panels. Furthermore, the resistance to shearing action (of the reinforcing cross-member 366 relative to the foam core 54) due to the friction generated between the foam core 54 and end portions 377 and 378, and due to the adhesion of the foam core 54 to the end portions 377 and 378, distributes the wind-load forces transferred through the reinforcing cross-members 366 into a portion of the foam core 54. However, not only do the reinforcing cross-member 366 spread the wind-load forces acting on the panels P spread through the foam core 54, but they also transfer the wind-load forces to the facer 50 via the first out-turned flange 371 and second out-turned flange 372. As such, the reinforcing cross-members 366 stabilize the panels P, and provide additional resistance to wind-load forces.

In the embodiment of FIG. 3C, a reinforcing cross-member, generally indicated by the numeral 466, is provided on the interior of and positioned longitudinally along the lower intermediate panel 28. The reinforcing cross-member 466 includes a first portion 467, a second portion 468, an interconnecting portion 470 joining the first portion 467 and second portion 468, a first out-turned flange 471 depending from the first portion 467 and a second out-turned flange 472 depending from the second portion 468. The reinforcing cross-members 466 (like the reinforcing cross-members 66, 266 and 366) can be integrally, mechanically, and/or adhesively fastened within the struts 60A and 60B, or can be held in place inside the struts 60A and 60B by the foam core 54.

The reinforcing cross-members 466 may partially conform to the interior dimensions of the struts 60A and 60B to ultimately allow the first portion 467 to abut the inner surface of the first segment 61, the second portion 468 to abut the inner surface of the second segment 62, and the interconnecting portions 470 to abut the inner surface of the interconnecting segments 64. Furthermore, the first out-turned flange 471 and second out-turned flange 472 are configured to abut the interior surface of the backer 52. That is, the first out-turned flange 471 and second out-turned flange 472 extend outwardly from the distal ends 477 and 478 of the first portion 467 and second portion 478, respectively, to interface with the backer 52. In doing so, the first out-turned flange 471 and second out-turned flange 472 provide for further reinforcement of the panels P. By interfacing the reinforcing cross-members 466 to not only the struts 60A and 60B, but also to portions of the remainder of the backer 52 using the first out-turned flange 471 and second out-turned flange 472, the reinforcing cross-members 466 allow wind-load forces acting on the panels P through the reinforcing cross-members 466 to be distributed into a portion of the foam core 54 between the backer 52 and facer 50.

In the embodiment of FIG. 3D, a reinforcing cross-member, generally indicated by the numeral 566, is provided on the interior of and positioned longitudinally along the lower intermediate panel 28. The reinforcing cross-member 566 includes a first portion 567, a second portion 568, an interconnecting portion 570 joining the first portion 567 and second portion 568, a first in-turned flange 573 depending from the first portion 567 and a second in-turned flange 574 depending from the second portion 568. The reinforcing cross-members 566 (like the reinforcing cross-members 66, 266, 366, and 466) can be integrally, mechanically, and/or adhesively fastened within the struts 60A and 60B, or can be held in place inside the struts 60A and 60B by the foam core 54.

The reinforcing cross-members 566 may partially conform to the interior dimensions of the struts 60A and 60B to ultimately allow the first portion 567 to abut the inner surface of the first segment 61, the second portion 568 to abut the inner surface of the second segment 62, and the interconnecting portion 570 to abut the inner surface of the interconnecting segments 64. Furthermore, the first in-turned flange 573 and second in-turned flange 574 can be configured to extend into the foam core 54 disposed between the facer 50 and backer 52 from the distal ends 577 and 578 of the first portion 567 and second portion 568, respectively. As seen in FIG. 3D, the first in-turned flange 573 and second in-turned flange 574 extend toward one another, and define a space 575 allowing the foam core 54 to expand therethrough when it is being poured and formed in situ. As such, the first in-turned flange 573 and second in-turned flange 574 are ultimately positioned within and enveloped by the foam core 54 disposed between the facer 50 and backer 52.

The envelopment of the first in-turned flange 573 and second in-turned flange 574 provides for further reinforcement of the panels P. Not only are the wind-load forces acting on the reinforcing cross-member 566 transferred to the foam core 54 due to the friction generated because the foam core 54 interfaces with the first in-turned flange 573 and second in-turned flange 574, and due to the adhesion of the foam core 54 to these in-turned flanges, but the wind-load forces are also transferred through the foam core 54 because the in-turned flanges effectively hook into the foam core 54 to resist movement of the reinforcing cross-members 566 relative thereto. As such, the resistance to shearing action (of the reinforcing cross-member 566 relative to the foam core 54) provided by the friction and adhesion between the foam core 54 and the in-turned flanges, and the resistance to movement of the reinforcing cross-members 566 relative to the foam core 54 provided by the in-turned flanges allows the wind-load forces acting on the panels P to be distributed into a portion of the foam core 54.

In the embodiment of FIG. 3E, a reinforcing cross-member, generally indicated by the numeral 666, is provided on the interior of and positioned longitudinally along the lower intermediate panel 28. The reinforcing cross-member 666 may have a trapezoidal cross-sectional shape, and includes a first portion 667, a second portion 668, an interconnecting portion 670 joining the first portion 667 and second portion 668 on one side of the reinforcing cross-member 666, and an interconnecting portion 672 joining the first portion 667 and second portion 668 on the other side of the reinforcing cross-member 666. The reinforcing cross-members 666 (like the reinforcing cross-members 66, 266, 366, 466, and 566) can be integrally, mechanically, and/or adhesively fastened within the struts 60A and 60B, or can be held in place inside the struts 60A and 60B by the foam core 54.

The reinforcing cross-members 666 may partially conform to the interior dimensions of the struts 60A and 60B to ultimately allow the first portion 667 to abut the inner surface of the first segment 61, the second portion 668 to abut the inner surface of the second segment 62, and the interconnecting portion 670 to abut the inner surface of the interconnecting segments 64. As seen in FIG. 3E, the interconnecting portion 672 can be provided within the foam core 54 disposed between the facer 50 and backer 52. Furthermore, the interconnecting portion 672 can have one or more apertures (or slots) 674 spaced along the longitudinal length thereof allowing the foam core 54 to expand therethrough when it is being poured and formed in situ. As such, when the foam expands through the apertures (or slots) 674, the remainder of the interconnecting portion 672 is positioned within and enveloped by the foam core 54 disposed between the facer 50 and backer 52. That is, the foam core 54 extends through the apertures (or slots) 674 such that the foam core 54 provided within the reinforcing cross-members 666 communicates with the foam core 54 disposed between the facer 50 and backer 52.

The envelopment of the interconnecting portion 672 provides for further reinforcement of the panels P. Not only are the wind-load forces acting on the reinforcing cross-member 666 transferred to the foam core 54 due to the friction generated because the foam core 54 interfaces with the interconnecting portion 672, and due to the adhesion of the foam core 54 to the interconnecting portion 672, but the wind-load forces are also transferred through the foam core 54 because the interconnecting portion 672 effectively hooks into the foam core 54 to resist movement of the reinforcing cross-members 666 relative thereto. As such, the resistance to shearing action (of the reinforcing cross-member 666 relative to the foam core 54) provided by the friction and adhesion between the foam core 54 and the interconnecting portion 672, and the resistance to movement of the reinforcing cross-members 666 relative to the foam core 54 provided by the interconnecting portion 672 allows the wind-load forces acting on the panels P to be distributed into a portion of the foam core 54.

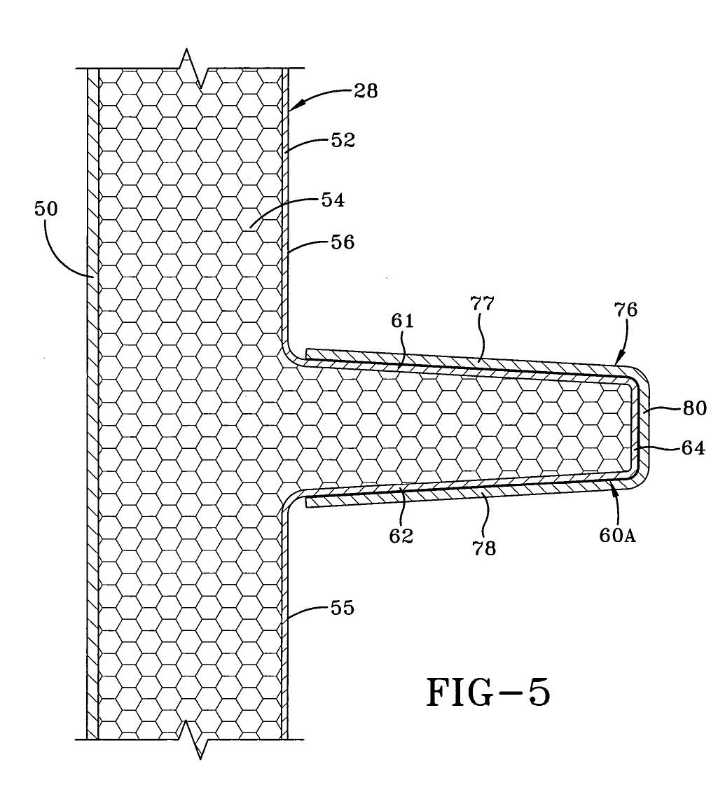

As seen in FIGS. 4 and 5, the alternate panel reinforcement system 20′ employs reinforcing cross-members, generally indicated by the numeral 76, which are provided on the exterior of and positioned longitudinally along the panels P. The reinforcing cross-members 76 include first portions 77, second portions 78, and interconnecting portions 80 joining the first portions 77 and second portions 78. The reinforcing cross-members 76 conform to the exterior dimensions of the struts 60A and 60B. That is, the reinforcing cross-members 76 are ultimately positioned along the exterior of the struts 60A and 60B, and can be mechanically and/or adhesively integrally fastened thereto. As such, the first portions 77 abut the outer surfaces of the first segments 61, the second portions 78 abut the outer surfaces of the second segments 62, and the interconnecting portions 80 abut the outer surfaces of the interconnecting segments 64. Ultimately, the reinforcing cross-members 76 add strength to the panels P to resist wind-load forces in the same manner as the reinforcing cross members 66.

The reinforcing cross-members 66, 76 can be inexpensively incorporated with the panels P, and, as discussed above, can be selectively sized to interface with the interiors and exteriors of the struts 60A, 60B. The reinforcing cross-members provide significant additional resistance to bending moments generated by wind-load forces. Furthermore, the reinforcing cross-members 66, 76 are relatively lightweight, and can be used with panels P without having to significantly reconfigure the operators, counterbalance systems, track system, and fastening requirements for the track systems. As such, the panel reinforcement systems 20 and 20′ employing the reinforcing cross-members 66 and/or reinforcing cross-members 76, respectively, have relatively high strength to weight ratios and are oriented to resist wind-load forces.

Referring to FIGS. 6 and 7, an alternate panel reinforcement system 20″ can be configured to employ reinforcements provided along the upper and lower extremities of panels having the configuration of the panels P′. The reinforcements can be reinforcing strips generally indicated by the numeral 90 in FIGS. 6 and 7. The reinforcing strips 90 are configured to be positioned adjacent the top edges and bottom edges of the panels P′. Although the panels P′ depicted in FIGS. 6 and 7 only include an upper intermediate panel 87 and a lower intermediate panel 88, these panels are indicative of the remaining panels P′ which would be used in forming sectional door D.

The upper intermediate panel 87 and lower intermediate panel 88 each include a top edge 92 and a bottom edge 93 having generally convex and concave shapes, respectively. The convex shapes of the top edges 92 and concave shapes of bottom edges 93 compliment one another to provide pinch resistant panel to panel interfaces for adjacent panels P′. As such, during articulation of a sectional door D employing panels P′ between open and closed positions, the top edges 92 and bottom edges 93 can be maintained in close proximity to one another to preclude fingers or other objects from entering therebetween and being pinched.

The reinforcing strips 90 are provided to reinforce the top edges 92 and bottom edges 93 to prevent binding and/or buckling of the panel P′ due to wind-load forces and/or articulation of the sectional door D between opened and closed positions. As seen in FIGS. 6 and 7, the reinforcing strips 90 are positioned within the panels P′ adjacent the top edges 92 and bottom edges 93.

The panels P′ include facers 94 and backers 96. Like the facers 50 and backers 52 associated with the panels P, the facers 94 and backers 96 can be formed from metallic and/or polymeric materials. Foam cores 98 are interposed between the facers 94 and backers 96. The foam cores 98 can be used to both insulate the panels P′, and to bond the facers 94 and backers 96 together. The foam cores 98 can be formed in situ, and, in cooperation with the configuration of the panels P′ adjacent the top edges 92 and bottom edges 93, integrally maintain the position of the reinforcing strips 90.

The top edges 92 and bottom edges 93 of the panels P′ can be formed from the facers 94 and/or backers 96. In the embodiment of panels P′ seen in FIGS. 6 and 7, the top edges 92 and bottom edges 93 are formed from the facers 94. To enhance the positioning of reinforcing strips 90 and the facers 94 and provide space for accommodating the reinforcing strips 90, the top edges 92 and bottom edges 93 include L-shaped extensions, generally indicated by the numerals 100 and 101, respectively, depending therefrom. The L-shaped extensions 100, 101 each include two segments. As shown, backer engaging segments 102 and 103 extend downwardly from the top edges 92 and upwardly from the bottom edges 93, respectively. Terminal segments 104 and 105 extend inwardly from the first segments 102 and 103, respectively. The segments 102, 103 can be adhered to the backers 96 to enhance the bond between the facers 94 and backers 96. Moreover, the L-shapes formed by the segment 102 and segment 104 and by the segment 103 and segment 105 can be respectively used to trap the reinforcing strips 90 adjacent the top edges 92 and bottom edges 93.

The reinforcing strips 90 are of a unitary hollow configuration and may have a generally rectangular cross-section. As shown, the reinforcing strips 90 have two parallel load walls 106 that are spaced and joined by connecting walls 106′. The connecting walls 106′ may engage the front and rear internal surfaces of the facers 94. The load walls 106 may be of a greater thickness and length than connecting walls 106′ to increase the portion of the reinforcing strips 90 serving to stiffen and strengthen the panels P′ due to their positioning substantially parallel to the forces imparted by wind loading on the panels 87, 88 when the door D is in the closed vertical position.

Like the reinforcing cross-members 66 and reinforcing cross-members 76, the reinforcing strips 90 can be incorporated within the panels P′ to provide significant additional resistance to bending moments generated by wind-load forces with a majority of the material of strips 90 aligned parallel to the wind force, i.e., perpendicular to the plane of the door D in the closed vertical position. The reinforcing strips 90 are relatively lightweight and can be used with panels P′ without having to significantly reconfigure the operators, counterbalance systems, track system, and fastening requirements for the track systems. As such, the panel reinforcement system 20″ employing the encapsulated reinforcing strips 90 have relatively high strength to weight ratios to resist wind-load forces.

Referring to FIGS. 8 and 9, another alternate panel reinforcement system 20′″ can be configured to employ reinforcements along the top and bottom extremities of panels P″ in the form of reinforced edge portions. Although the panels P″ depicted in FIGS. 8 and 9 only include an upper intermediate panel 107 and a lower intermediate panel 108, these panels are indicative of the remaining panels P″ which would be used in forming sectional door D.

As seen in FIGS. 8 and 9, the upper intermediate panel 107 and lower intermediate panel 108 include top reinforcement edge portions 112 and bottom reinforcement edge portions 113. Each of the top reinforcement edge portions 112 include a top interface surface 112A and each of the bottom reinforcement edge portions 113 include a bottom interface surface 113A. The top interface surfaces 112A and bottom interfaces surfaces 113A have substantially convex and concave shapes, respectively. The shapes of the first interface surface 112A and second interface surface 113A compliment one another to provide pinch resistant panel to panel interfaces between adjacent panels P″. As such, during articulation of a sectional door D (employing panels P″) between open and closed positions, the top interface surface 112A and bottom interface surface 113A can be maintained in close proximity to one another to preclude a bystander's fingers or hands from entering therebetween and being pinched.

The top reinforcement edge portions 112 and bottom reinforcement edge portions 113 20 are formed by roll-forming the longitudinal edges of the panels P″. The top reinforcement edge portions 112 and bottom reinforcement edge portions 113 advantageously help in preventing binding and/or buckling of the panel P″ due to wind-load forces and/or articulation of the sectional door D between opened and closed positions.

The panels P″ include facers 114 and backers 116, and foam cores 117 interposed between the facers 114 and backers 116. The surfaces of the facers 114 and backers 116 opposite the foam cores 117 ultimately form the exterior surfaces 118 and exterior surfaces 119, respectively, of the panels 107, 108. The foam cores 117 can be formed from polymeric materials such as polyurethane and polystyrene, and the facers 114 and backers 116 can be formed from metallic materials or polymeric materials. For example, as seen in FIGS. 8 and 9, the facers 114 may be formed from metallic materials, and the backers 116 may be formed from polymeric materials.

The top reinforcement edge portions 112 and bottom reinforcement edge portions 113 are integrally formed with the facers 114. That is, the longitudinal edges of the facers 116 are roll formed, or otherwise fabricated to configure the top reinforcement edge portions 112 and bottom reinforcement edge portions 113. However, as those skilled in the art will appreciate, the longitudinal edges of the facers 114, provided that the facers 114 are formed from metallic materials, can also be rolled to form one or both of the top reinforcement edge portions 112 and bottom reinforcement edge portions 113. As such, the top reinforcement edge portions 112 and bottom reinforcement edge portions 113 could alternatively be formed from the backers 116.

As seen in FIGS. 8 and 9, the top reinforcement edge portions 112 include four sections, each formed of various layers through the roll-forming process. As discussed above, the top reinforcement edge portions 112 are integrally formed from the facers 114. Each segment of the top reinforcement edge portions 112 is composed of various layers which are actually portions of the facer 114 positioned adjacent to one another during the roll-forming process. To illustrate, the top reinforcement edge portions 112 are formed from a first segment 121, a second segment 122, a third segment 123, and a fourth segment 124. Each of these segments 121, 122, 123, and 124 includes at least two layers formed from roll formed portions of the facers 114. More or less layers could be employed depending upon strength requirements for a particular design.

As shown, the first segment 121 includes a first layer 121A, a second layer 121B, and a third layer 121C. The second segment 122 includes a first layer 122A, a second layer 122B, and a third layer 122C. The third segment 123 includes a first layer 123A, a second layer 123B, and a third layer 123C. Finally, the fourth segment 124 includes a first layer 124A and a second layer 124B. Except where one layer transitions into another layer, when moving from the first segment 121 to the second segment 122 to the third segment 123 to the fourth segment 124, layers labeled “A” are successively attached, layers labeled “B” are successively attached, and layers labeled “C” are successively attached. That is, for example, the first layer 121A is attached to the first layer 122A, the first layer 122A is attached to the first layer 123A, and the first layer 123A is attached to the first layer 124A. As seen best in FIG. 9, the fourth segment 124 does not include a third layer, but instead incorporates a portion of the backer 116 which forms the interior surface 119 of the panel 108.

As seen best in FIG. 9, the second segment 122 and fourth segment 124 are spaced and joined by the first segment 121. The second segment 122 and fourth segment 124 are opposed to one another, and are perpendicularly oriented with respect to the first segment 121. The third segment 123 also joins the second segment 122 and fourth segment 124, but, rather than being perpendicularly oriented with respect to the second segment 122 and fourth segment 124, the third segment 123 is in part bowed slightly outwardly to approximate the above-described convex shape of edge portions 112. The first interface surface 112A can be formed from the third layer 123C of the third segment 123.

As also seen in FIGS. 8 and 9, the bottom reinforcement edge portions 113 include four sections, each formed of various layers through a roll-forming process. Like the top reinforcement edge portions 112, each of the bottom reinforcement edge portions 113 are composed of various layers which are actually portions of the facer 114 positioned adjacent to one another during the roll-forming process. To illustrate, the top reinforcement edge portions 112 are formed from a first segment 131, a second segment 132, a third segment 133, and a fourth segment 134. Each of these segments, 131, 132, 133, and 134 includes at least two layers formed from roll formed portions of the second facers 116. ore or less layers could be employed depending upon strength requirements for a particular design.

For example, the first segment 131 includes a first layer 131A, a second layer 131B, and a third layer 131C. The second segment 132 includes a first layer 132A, a second layer 132B, and a third layer 132C. The third segment 133 includes a first layer 133A, a second layer 133B, and a third layer 133C. Finally, the fourth segment 134 includes a first layer 134A and a second layer 134B.

Except where one layer transitions into another layer, when moving from the first segment 131 to the second segment 132 to the third segment 133 to the fourth segment 134, 25 layers labeled “A” are successively attached, layers labeled “B” are successively attached, and layers labeled “C” are successively attached. That is, for example, the first layer 131A is attached to the first layer 132A, the first layer 132A is attached to the first layer 133A, and the first layer 133A is attached to the first layer 134A. As seen best in FIG. 9, the fourth segment 134 does not include a third layer, but instead incorporates a portion of the facer 114 which forms the exterior surface 118 of the panel 107.

As seen best in FIG. 9, the second segment 132 and fourth segment 134 are spaced and joined by the first segment 131. The second segment 132 and fourth segment 134 are opposed to one another, and are perpendicularly oriented with respect to the first segment 131. The third segment 133 also joins the second segment 132 and fourth segment 134, but, rather than being perpendicularly oriented with respect to the second segment 132 and fourth segment 134, the third segment 133 is generally bowed inwardly to approximate the above-described convex shape of edge portions 113. In fact, the second interface surface 113A can be formed from the third layer 133C of the third segment 133.

As such, the rolled-formed top reinforcement edge portions 112 and bottom reinforcement edge portions 113 can be incorporated into the panels P″ to provide significant additional resistance to bending moments generated by wind-load forces with a majority of the material of reinforcement edge portions 112, 113 aligned parallel to the wind force, i.e., perpendicular to the plane of the door D in the closed vertical position. The top reinforcement edge portions 112 and bottom reinforcement edge portions 113 add relatively little additional weight to the panels P″, and, therefore, the operators, counterbalance systems, track system, and fastening requirements for the track systems do not have to be significantly reconfigured. As such, the panel reinforcement system 20 employing the top reinforcement edge portions 112 and bottom reinforcement edge portions 113 have relatively high strength to weight ratios to resist wind-load forces.

It will be apparent to persons skilled in the art that the door D may be configured with panels having a combination of reinforced panel edges and reinforced struts on the backer. In that respect, such a panel might have reinforcing strips 90 at one or both edges 92, 93 or reinforced edge portions 112, 113 coupled with one or more struts 60A, 60B having reinforcing cross-members 66 or 76.

Thus, it should be evident that the reinforced sectional door panels disclosed herein carry out one or more of the objects of the present invention set forth above and otherwise constitute an advantageous contribution to the art. As will be apparent to persons skilled in the art, modifications can be made to the embodiments disclosed herein without departing from the spirit of the invention, the scope of the invention herein being limited solely by the scope of the attached claims.

1. A sectional door panel comprising, a facer, a backer, a core interposed between said facer and said backer, said backer including at least one protruding element extending outwardly therefrom and longitudinally thereof, a reinforcing member positioned longitudinally along said protruding element, and a reinforcing strip positioned adjacent one of an upper edge and a lower edge of the panels and extending longitudinally thereof.

2. A sectional door panel of claim 1, wherein a majority of the material of said reinforcing member and said reinforcing strip is oriented in a direction substantially perpendicular to the plane of the panel.

3. A sectional door panel comprising, a facer, a backer, a core interposed between said facer and said backer, said backer including at least one protruding element extending outwardly therefrom and longitudinally thereof, and a reinforcing member positioned longitudinally along said at least one protruding element, said reinforcing member having a majority of the material thereof oriented in a direction substantially perpendicular to the plane of the panel.

4. A sectional door panel according to claim 3, wherein said protruding element is a strut.

5. A sectional door panel according to claim 3, wherein said backer encloses said protruding element and said reinforcing member is positioned exteriorly of said backer.

6. A sectional door panel according to claim 3, wherein said backer encloses said protruding element and said reinforcing member is positioned interiorly of said backer.

7. A sectional door according to claim 3, wherein said reinforcing member has a first portion, a second portion and an interconnecting portion selectively sized to interface with one of the interior and the exterior of said protruding element.

8. A sectional door according to claim 3, wherein said reinforcing member has a first portion and a second portion, said first portion and said second portion extending into and being encapsulated by said core.

9. A sectional door according to claim 3, wherein said reinforcing member has a first portion with a first flange depending therefrom and a second portion with a second flange depending therefrom, said first portion and said second portion extending through said core to allow said first flange and said second flange to interface with said facer.

10. A sectional door according to claim 3, wherein said reinforcing member has a first portion with a first flange depending therefrom and a second portion with a second flange depending therefrom, said first flange and said second flange extending outwardly to interface with said backer.

11. A sectional door according to claim 3, wherein said reinforcing member has a first portion with a first flange depending therefrom and a second portion with a second flange depending therefrom, said first flange and said second flange extending inwardly toward one another, and said first flange and said second flange allowing said reinforcing member to hook into said core.

12. A sectional door according to claim 3, wherein said reinforcing member has a first portion, a second portion and an interconnecting portion joining said first portion and said second portion, and wherein said interconnecting portion has at least one aperture formed therein, said core extending through said at least one aperture into said reinforcing member.

13. A sectional door according to claim 3, wherein said facer and said backer are laminated to one another by said foam core, and said reinforcing member is pressed against the interior of said backer portion covering said protruding element by said foam core.

14. A sectional door according to claim 3, wherein said reinforcing member is selectively adhesively attached to said reinforcing member.

15. A sectional door according to claim 3, wherein said reinforcing member is integrally incorporated into the panel.

16. A sectional door panel comprising, a facer, a backer, a core interposed between said facer and said backer, at least one reinforcing strip positioned adjacent one of an upper edge and a lower edge of the panel and extending longitudinally thereof, said reinforcing strip having a majority of the material thereof oriented in a direction substantially perpendicular to the plane of the panel.

17. A sectional door according to claim 16, wherein said reinforcing strip has a hollow, substantially rectangular cross-sectional configuration.

18. A sectional door according to claim 17, wherein said reinforcing strip is a unitary body integrally positioned within one of said upper edge and said lower edge.

19. A sectional door according to claim 16, wherein said reinforcing strip is encapsulated within the panel by either of said facer and said backer.

20. A sectional door according to claim 19, wherein said core is foamed and said reinforcing strip is bounded on one side by said core and on three sides by either of said facer and said backer.

21. A sectional door according to claim 16, wherein said reinforcing strip has spaced, parallel load walls and connecting walls, said load walls being oriented substantially perpendicular to the plane of the panel.

22. A sectional door according to claim 17, wherein said load walls are of a greater thickness than said connecting walls.

23. A sectional door according to claim 16, wherein said reinforcing strips are positioned at both said upper edge and said lower edge of the panel.

24. A sectional door according to claim 16, wherein said reinforcing strip is integrally formed from one of said facer and said backer.

25. A sectional door according to claim 16, wherein said reinforcing strip has a hollow, generally rectangular cross-sectional configuration.

26. A sectional door according to claim 16, wherein said reinforcing strip has a plurality of connected segments each having a plurality of adjacent layers of one of said facer and said backer.

27. A sectional door according to claim 26 wherein one segment of said connected segments of said reinforcing strip forms one of said upper edge and said lower edge with portions of an adjacent layer engaging said one segment.

28. A sectional door according to claim 27, wherein two of said connected segments are oriented substantially perpendicular to the plane of the panel and are of greater length than said connected segments joining said two of said connected segments.
